(19) United States
(12) Patent Application Publication
(10) Pub. No.: US 2026/0040131 A1
(43) Pub. Date: Feb. 5, 2026

(54) WTRU CONFIGURATION FOR MEDIA FLOWS

(71) Applicant: InterDigital Patent Holdings, Inc., Wilmington, DE (US)

(72) Inventors: Achref Methenni, Montreal (CA); Michael Starsinic, Newtown, PA (US); Anuj Sethi, Ottawa (CA); Magurawalage Chathura Madhusanka Sarathchandra, London (GB); Xavier De Foy, Kirkland (CA); Kevin Di Lallo, Laval (CA); Rocco Di Girolamo, Laval (CA); Michel Roy, Candiac (CA)

(73) Assignee: InterDigital Patent Holdings, Inc., Wilmington, DE (US)

(21) Appl. No.: 18/794,235

(22) Filed: Aug. 5, 2024

(51) Int. Cl. H04W 28/02

(52) U.S. Cl. CPC H04W 28/0268

(57) ABSTRACT

Systems, methods, devices, and instrumentalities described herein may be used to process and/or provide supplemental QoS rules. A first message may be received from a first network node. The first message may comprises a first Quality of Service (QOS) rule Information Element (IE) and a second QoS rule IE. The first QoS rule IE may be associated with a first QoS rule. The second QoS rule IE may be associated with a second QoS rule. A data packet to be sent to a second network node may be determined. An uplink QoS flow identification (ID) associated with the data packet may be determined based on at least one of the first QoS rule or the second QoS rule. A second message may be sent to a second network node. The second message may comprise the data packet and may indicate the uplink QoS flow ID.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, devices, and instrumentalities are provided herein for processing supplemental QoS rules. For example, a method or a wireless transmit/receive unit (WTRU) that may perform the method may be provided to process supplemental QoS rules. A first message may be received from a first network node. The first message may be a Protocol Data unit (PDU) session modification message. The PDU session modification message may include a first Quality of Service (QOS) rule Information Element (IE) and a second QoS rule IE. The first QoS rule IE may be associated with a first QoS rule. The first QoS rule IE may indicate a first QoS flow ID and a first packet filter. The second QoS rule IE may be associated with a second QoS rule. The second QoS rule IE may indicate a second Qos flow ID and a second packet filter.

The WTRU may determine a data packet to be sent to a second network node. The data packet may be associated with an application. The WTRU may determine an uplink (UL) QoS flow identification (ID) associated with the data packet based on at least one of the first QoS rule or the second QoS rule. On condition that the data packet matches the first packet filter and does not match the second packet filter, the UL QoS flow ID may be determined to be the first QoS flow ID. On condition that data packet matches the first and second packet filters, the UL QoS flow ID may be determined to be the second QoS flow ID. The WTRU may send a second message to a second network node. The second message may include the data packet and indicates the uplink QoS flow ID.

The second QoS rule IE may be a supplemental QoS Rule IE. The first packet filter may be associated with a first stream identification (ID) value. The second packet filter may be associated with a second stream ID value. The first stream ID value may be different from the second stream ID value.

The WTRU may determine an uplink QoS flow ID associated with the data packet based on the at least one of the first QoS rule or the second QoS rule by determining that the uplink QoS flow ID is the first QoS flow ID based on the packet matching the first packet filter.

The WTRU may determine an uplink QoS flow ID associated with the data packet based on the at least one of the first QoS rule or the second QoS rule by determining that the uplink QoS flow ID is the second QoS flow ID based on the packet matching the second packet filter.

The WTRU may determine an uplink QoS flow ID associated with the data packet based on at least one of the first QoS rule or the second QoS rule by determining that the uplink QoS flow ID is the first QoS flow ID by based on the second QoS rule.

The WTRU may determine an uplink QoS flow ID associated with the data packet based on the at least one of the first QoS rule or the second QoS rule by determining that the packet matches the first packet filter and the second packet filter; determining a precedence rule to select the uplink QoS flow ID using the first QoS rule and the second QoS rule; and selecting the uplink QoS flow ID using the determined precedence rule.

The WTRU may determine that the WTRU supports the second QoS rule. The WTRU may send a PDU session modification complete message to the first network node. The PDU session modification complete message may indicate that the WTRU supports the second QoS rule.

Systems, methods, devices, and instrumentalities are provided herein for processing supplemental QoS rules. For example, a method or a first network node may be provided to process supplemental QoS rules. A first network node may receive a first message from a second network node. The first message may indicate a first policy and charging control (PCC) rule, a second PCC rule, and an indication that the first PCC rule is associated with the second PCC rule. The first network node may determine that the second PCC rule is to be applied to a WTRU that supports a supplemental Quality of Service (QOS) rule feature. The first network node may determine a first QoS rule using the first PCC rule. The first network node may determine a second QoS rule using the second PCC rule. The second QoS rule may be a supplemental QoS rule.

The first network node may send a second message to the WTRU. The second message may include a first QoS rule IE and a second QoS rule IE. The first QoS rule IE may be associated with a first QoS rule. The first QoS rule IE may indicate a first QoS flow ID and a first packet filter. The second QoS rule IE may be associated with a second QoS rule. The second QoS rule IE may indicate a second QoS flow ID and a second packet filter.

The first network node may send a third message to a third network node. The third message may indicate that the WTRU supports the supplemental QoS rule feature. The second QoS rule IE may further indicate that the second QoS rule is associated with the first QoS rule.

The first packet filter may be associated with a first stream ID value. The second packet filter may be associated with a second stream ID value. The first stream ID value may be different from the second stream ID value.

The first network node may receive a PDU session modification complete message from the WTRU. The PDU session modification complete message may indicate that the WTRU supports the second QoS rule. The first network node may receive a fifth message from the third network node. The fifth message may indicate that the WTRU supports the second QoS rule.

The first network node may receive a fifth message from the third network node. The fifth message may indicate data traffic information. The first network node may determine that the WTRU supports the second QoS rule based on a determination that the data traffic information is associated with the second QoS flow.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIGS. 2A and 2B illustrate example signaling associated with provisioning a packet filter information element and quality of service (QOS) flow handling.

### DETAILED DESCRIPTION

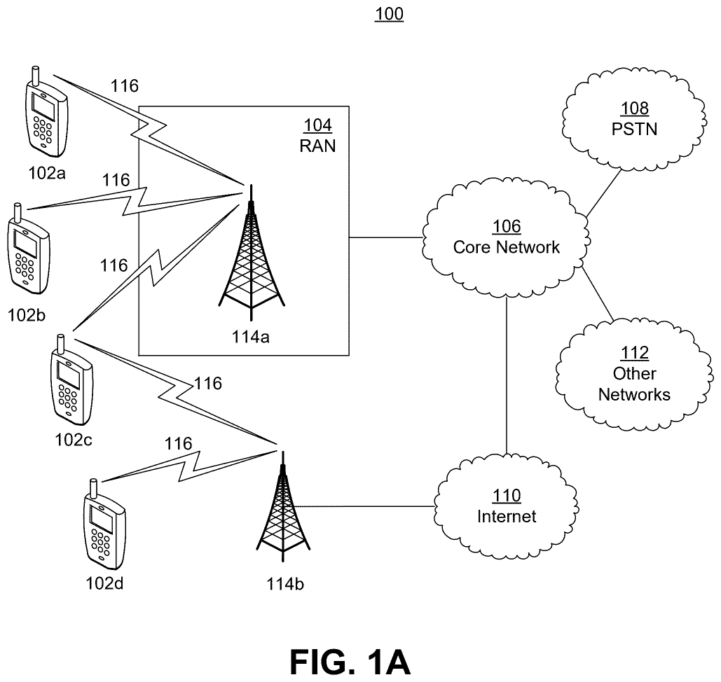

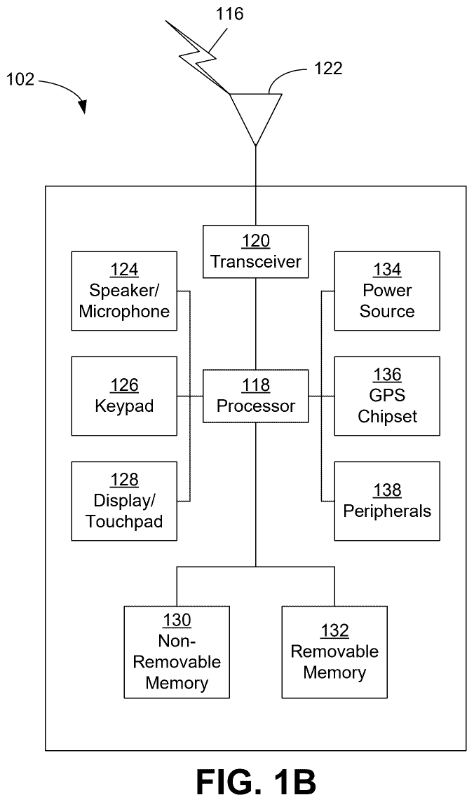

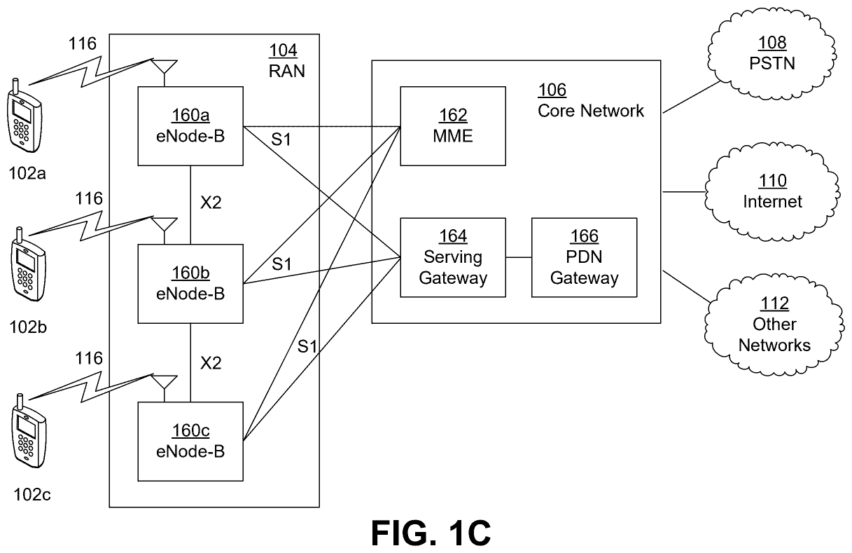

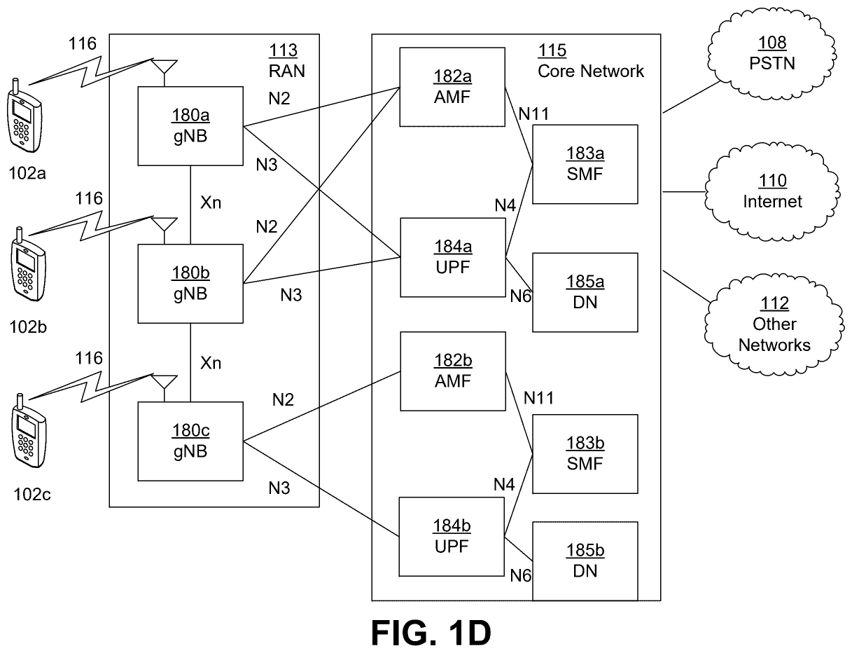

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

The following abbreviations and acronyms are used throughout this disclosure.

| | |
|---|---|
| 5GC | 5G Core |
| 5GS | 5G System |
| 5QI | 5G QoS Identifier |
| AF | Application Function |
| API | Application Programming Interface |
| AS | Application Server |
| AMF | Access and Mobility Management Function |
| ID | Identifier |
| IE | Information Element |
| DQR | Default QoS rule identifier |
| FAR | Forwarding Action Rule |
| GBR | Guaranteed bit rate |
| GFBR | Guaranteed Flow Bit Rate |
| GTP-U | GPRS Tunneling Protocol - User plane |
| MASQUE | Multiplexed Application Substrate over QUIC |
| | Encryption |
| Mbps | Megabits per second |
| MBR | Maximum bit rate |
| MFBR | Maximum Flow Bit Rate |
| MOQ | Media over QUIC |
| NAS | Non-Access Stratum |
| NAS-SM | NAS-Session Management |
| NEF | Network Exposure Function |
| PCC | Policy and Charging Control |
| PCF | Policy Control Function |
| PDI | Packet Detection Information |
| PDR | Packet Detection Rule |
| PDU | Packet Data Unit |
| PSI | PDU Set Importance |
| QER | QoS Enforcement Rule |
| QFI | QoS Flow Identifier |
| QoS | Quality of Service |
| QRI | QoS rule Identifier |
| QUIC | Quick UDP Internet Connections |
| RQA | Reflective QoS Attribute |
| RQI | Reflective QoS Indication |
| RTP | Real-time Transport Protocol |
| SMF | Session Management Function |
| UDP | User Datagram Protocol |
| UE | User Equipment |
| UPF | User Plane Function |
| WTRU | Wireless Transmit/Receive Unit |
| XRM | eXtended Reality and Multimodal services |

Example terminology is provided herein. The terms media streams and media flows may be used interchangeably.

Systems, methods, devices, and instrumentalities are provided herein for processing supplemental QoS rules. For example, a method or a WTRU that may perform the method may be provided that may process supplemental QoS rules. A first message may be received from a first network node. The first message may comprise a first Quality of Service (QOS) rule Information Element (IE) and a second QoS rule IE. The first QoS rule IE may be associated with a first QoS rule. The second QoS rule IE may be associated with a second QoS rule. A data packet to be sent to a second network node may be determined. The data packet may be associated with an application. An uplink QoS flow identification (ID) associated with the data packet may be determined based on at least one of the first QoS rule or the second QoS rule. A second message may be sent to a second network node. The second message may comprise the data packet and may indicate the uplink QoS flow ID.

In an example, the first message may be a Protocol Data Unit (PDU) session modification message. The first QoS rule IE may indicate a first QoS flow ID and a first packet filter. The second Qos rule IE may indicate a second QoS flow ID and a second packet filter. The second QoS rule IE may be a supplemental QoS Rule IE.

In an example, the first packet filter may be associated with a first flow identification (ID) value. The second packet filter may be associated with a second stream ID value. The first stream ID value may be different from the second stream ID value.

In an example, an uplink QoS flow ID associated with the data packet may be determined based on the at least one of the first QoS rule or the second QoS rule. For example, it may be determined that the uplink QoS flow ID is the first QoS flow ID based on the packet matching the first packet filter.

In an example, an uplink QoS flow ID associated with the data packet may be determined based on the at least one of the first QoS rule or the second QoS rule. For example, it may be determined that the uplink QoS flow ID is the second QoS flow ID based on the packet matching the second packet filter.

In an example, an uplink QoS flow ID associated with the data packet may be determined based on at least one of the first QoS rule or the second QoS rule. For example, it may be determined that the uplink QoS flow ID is the first QoS flow ID by based on the second QoS rule.

In an example, an uplink QoS flow ID associated with the data packet may be determined based on the at least one of the first QoS rule or the second QoS rule. For example, it may be determined that the packet matches the first packet filter and the second packet filter. A precedence rule to select the uplink QoS flow ID may be determined using the first QoS rule and the second QoS rule. The uplink QoS flow ID may be selected using the determined precedence rule.

In an example, it may be determined that that the WTRU supports the second QoS rule. A PDU session modification complete message may be sent to the first network node. The confirmation message may indicate that the WTRU supports the second QoS rule.

Systems, methods, devices, and instrumentalities are provided herein for processing supplemental QoS rules. For example, a method or a first network node may be provided to process supplemental QoS rules. A first message may be received from a second network node. The first message may indicate a first policy and charging control (PCC) rule, a second PCC rule, and an indication that the first PCC rule is associated with the second PCC rule. It may be determined that the second PCC rule is to be applied to a WTRU that supports a supplemental Quality of Service (QOS) rule feature. A first QoS rule may be determined using the first PCC rule. A second QoS rule may be determined using the second PCC rule. The second QoS rule may be a supplemental QoS rule. A second message may be sent to the WTRU. The second message may comprise a first QoS rule information element (IE) associated with the first QoS rule, and a second QoS rule IE associated with the second QoS rule. A third message may be sent to a third network node. The third message may indicate that the WTRU supports the supplemental QoS rule feature.

In an example, the second message may be a Protocol Data Unit (PDU) session modification message. The first QoS rule IE may indicate a first QoS flow ID and a first packet filter. The second QoS rule IE may indicate a second QoS flow ID and a second packet filter.

In an example, the second QoS rule IE may further indicate that the second QoS rule is associated with the first QoS rule.

In an example, the first packet filter may be associated with a first flow identification (ID) value. The second packet filter may be associated with a second stream ID value. The first stream ID value may be different from the second stream ID value.

In an example, a PDU session modification complete message may be received from the WTRU. The confirmation message may indicate that the WTRU supports the second QoS rule.

In an example, a fifth message may be received from the third network node. The fifth message may indicate that the WTRU supports the second QoS rule.

In an example, a fifth message may be received from the third network node. The fifth message may indicate data traffic information. It may be determined that the WTRU supports the second QoS rule based on a determination that the data traffic information is associated with the second QoS flow.

Feature(s) associated with QoS rules (e.g., supplemental QoS rules) are provided herein.

Example WTRU actions are provided herein.

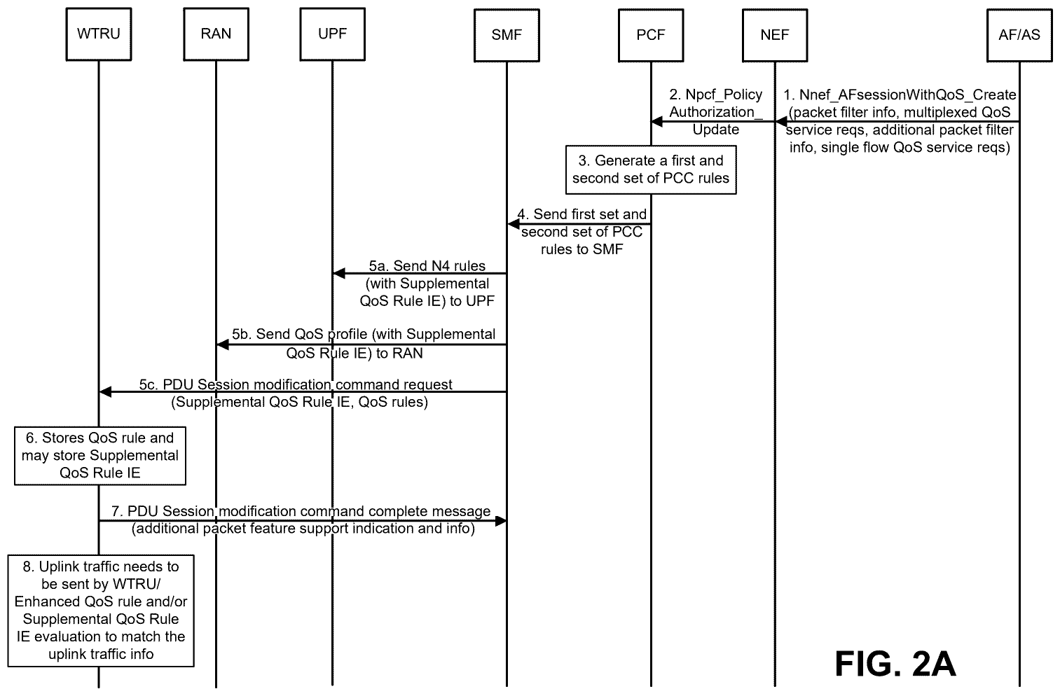

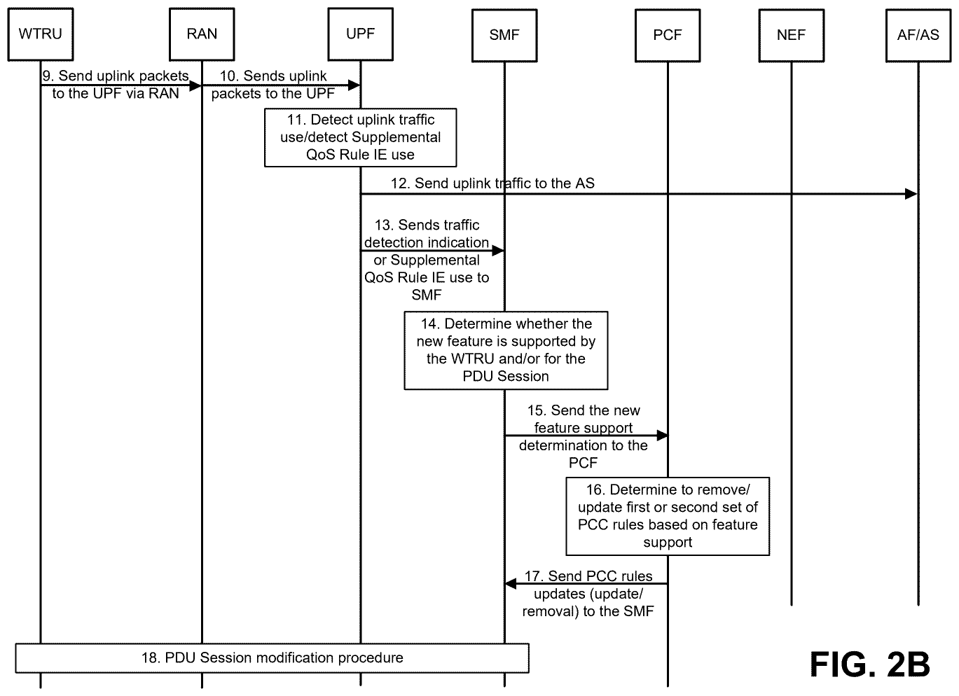

As illustrated in FIG. 2A, at 5c-6, the WTRU may receive a QoS rule IE and/or a supplemental QoS rule IE. The QoS rule IE may include a first QoS Flow ID and/or a first packet filter. The supplemental QoS rule IE may include an indication that it is associated with the QoS rule IE. The supplemental QoS rule IE may include (e.g., at least) a second packet filter and/or a second QoS Flow ID that is associated with the second packet filter. The packet filter may indicate a stream ID value. The first QoS Flow ID and the second QoS Flow ID may be different.

The QoS rule IE and/or a supplemental QoS rule IE may be received in a PDU Session Modification Command message.

The first packet filter and second packet filter may be different. Traffic that matches the first packet filter may not match the second packet filter. Traffic that matches the second packet filter may match the first packet filter.

At 7, the WTRU may (e.g., in response to receiving the supplemental QoS rule IE) send an indication to the network that the WTRU supports the supplemental QoS rule IE feature. The support indication may be sent by the WTRU to the network in a PDU Session Modification Command Complete message.

At 9 and 10, the UPF may receive a packet (e.g., via a RAN) from a WTRU application for uplink transmission.

At 8, the WTRU may determine that the traffic is associated with the QoS rule (e.g., based on the packet matching the first packet filter) QoS rule. At 8, the WTRU may determine that the traffic is associated with the supplemental QoS rule (e.g., based on the supplemental QoS rule IE, which may include an indication that the IE is associated with the QoS rule) supplemental QoS rule.

In a first example, at 8, the WTRU may determine that the traffic is associated with the second QoS Flow ID (e.g., based on the packet matching the second packet filter). In a second example, at 8, the WTRU may determine that the traffic is associated with the first QoS Flow ID (e.g., based on the packet not matching the second packet filter).

At 9, the WTRU may transmit the packet and the first or second QoS Flow ID to the network.

Example SMF actions are provided herein. At 4, the SMF may receive a first PCC Rule, a second PCC Rule, and an indication that the PCC Rules are associated (e.g., with each other). The first PCC Rule may be applied to a WTRU that supports the supplemental QoS rule IE feature.

At 4 and 5, the SMF may use the second PCC Rule to derive a QoS rule. The SMF may use the first PCC Rule and second PCC Rule to derive a supplemental QoS rule IE.

At 5c, the SMF may transmit the QoS rule and supplemental QoS rule IE to a WTRU. The QoS rule IE may include a first QoS Flow ID and a first packet filter. The supplemental QoS rule IE may include an indication that the IE is associated with the QoS rule IE. The supplemental QoS rule IE may include at least a second packet filter and a second QoS Flow ID that is associated with the second packet filter.

The packet filter may indicate a steam ID value. The first QoS Flow ID and the second QoS Flow ID may be different.

The QoS rule IE and a supplemental QoS rule IE may be sent in a PDU Session Modification Command message.

The first packet filter and second packet filter may be different. Traffic that matches the first packet filter may not match the second packet filter. Traffic that matches the second packet filter may match the first packet filter.

At 7, in response to sending the supplemental QoS rule IE, the SMF may receive an indication that the WTRU supports the supplemental QoS rule IE feature.

The support indication may be sent by the WTRU to the network in a PDU Session Modification Command Complete message.

At 12, the SMF may receive information from the UPF. The SMF may use the information from that UPF to determine that the WTRU supports the supplemental QoS rule IE feature.

The information from the UPF may be an indication that traffic was detected in a QoS Flow.

At 14, the SMF may send an indication to the PCF that the WTRU supports the supplemental QoS rule IE feature.

Feature(s) associated with multiplexed data flows (e.g., in the 5G system) are provided herein.

Media streams may be multiplexed on an (e.g., the same) end-to-end transport layer connection. A (e.g., each) media stream may have different QoS specifications (e.g., parameters or requirements). An end-to-end transport layer connection may be described by a 4-tuple. A 4-tuple may be a Source IP Address, a Source Port Number, a Destination IP Address, and a Destination Port Number.

A packet filter (e.g., an additional packet filter) may be provided to the UPF (e.g., with the legacy packet filter). For example, the legacy packet filter may be a 4-tuple, and the additional packet filter may be used to differentiate a media flow (e.g., among multiple media flows that share the same legacy packet filter in the downlink). The additional packet filter and legacy packet filter may be provided to the UPF by the SMF. The SMF may include the additional packet filter and legacy packet filter in the N4 rules that are sent to the UPF.

A packet filter (e.g., an additional packet filter) may be provided to the WTRU (e.g., along with the legacy packet filter). For example, the legacy packet filter may be a 4-tuple. The additional packet filter may be used to differentiate a media flow (e.g., among multiple media flows that share the same legacy packet filter in the uplink). The additional packet filter and legacy packet filter may be provided to the WTRU by the SMF. The SMF may include the additional packet filter and legacy packet filter in the QoS rules that are sent to the WTRU.

The SMF may receive the additional packet filter(s) for uplink and/or downlink data from the PCF. The PCF may include the additional packet filter(s) in the PCC rules. The PCC rule may be sent to the SMF for the PDU Session that carries the media streams.

Example QoS rules are provided herein.

QOS rules may refer to rules that are used and stored in a WTRU to allow a WTRU to classify uplink traffic, associate it with a specific QoS flow identifier, and/or mark the uplink traffic.

QOS rules may include a QoS flow identifier (e.g., QFI), a packet filter set that enables the WTRU to identify the traffic, and/or a precedence value. The lower the precedence value of a QoS rule, the higher its priority may be (e.g., meaning that it is evaluated earlier by the WTRU).

The QoS rule information element may include other fields (e.g., such as the length of QoS rule). The size or length of the QoS rule may vary (e.g., depending on the number and size of the packet filters in the packet filter list). The length of QoS rule IE may indicate such a size or length.

A field (e.g., other fields) in the QoS rule IE may include the number of packet filters in the QoS rule. The QoS rule IE may include a field (e.g., DQR) in the QoS rule IE that may indicate whether the QoS rule is a default QoS rule. The QoS rule IE may include a field that describes or represents the type of operation that is associated with the QoS rule. For example, the rule operations may include creating a new QoS rule, deleting an existing QoS rule, or modifying an existing QoS rule, etc.

A QOS rule may be signaled to the WTRU (e.g., by the 5GS). A QOS rule may be preconfigured in the WTRU. A QoS rule may be derived by the WTRU (e.g., using reflective QoS). A QoS rule (e.g., each QoS rule) may have a QoS rule identifier. The QoS rule identifier may be unique within a PDU session (e.g., if the QoS rule is explicitly signaled). If the QoS rule is explicitly signaled, the SMF may generate the QOS rule identifier.

The WTRU may be provided with the QoS rule via a NAS-SM message. Example NAS-SM messages may include a PDU session establishment accept message and/or a PDU session modification command message.

If a PDU session is established (e.g., or the PCF determines to configure PCC rules for a PDU session that carries media streams), the system (e.g., 5GC) may not be aware of whether the WTRU is able to interpret additional packet filter(s). For example, network nodes (e.g., the SMF) may not know if the WTRU was designed to support the additional packet filter(s). The SMF may not know whether to configure additional packet filter(s) in the QoS rules it sends to the WTRU.

The WTRU may indicate to the SMF whether the WTRU supports the additional packet filter(s) feature. For example, the WTRU may include an indication that the WTRU supports the additional packet filter(s) feature (e.g., in the PDU session establishment request that the WTRU sends to the SMF). If the WTRU indicates to the SMF that the WTRU supports the feature, the WTRU may (e.g., may need to) send extra information to the SMF. In this case, the SMF may (e.g., may need to) configure WTRUs (e.g., in a different manner). For example, the SMF may configure a WTRU that supports the feature with the additional packet filter(s). The SMF may configure a WTRU that does not support the feature without the additional packet filter(s).

The system (e.g. 5G system) may not provide a support-independent method for configuring WTRU(s) to handle the case where more than one (e.g., several) uplink media streams are multiplexed onto the same end-to-end transport layer connection. A support-independent method for configuring WTRU(s) may refer to a method in which the SMF may configure WTRUs with the same information for handling uplink media streams without regard to whether the WTRU supports the additional packet filter feature. A WTRU that supports the additional packet filter feature may use the configuration information from the SMF more efficiently than a WTRU that does not support the additional packet filter feature. A WTRU that supports the feature may be more efficient because a WTRU that supports the feature may be able to provide different QoS for media streams (e.g., each media stream in the end-to-end transport layer connection). A WTRU that does not support the additional packet filter feature may provide uplink QoS for the same end-to-end transport layer connection. The WTRU that does not support the feature may not provide different QoS for media streams (e.g., each media stream in the end-to-end transport layer connection).

The SMF may configure the WTRUs with configuration information for handling uplink media streams in a support independent manner (e.g., without regard to whether the WTRU supports the additional packet filter feature or not). A WTRU that supports the additional packet filter feature may use the configuration information from the SMF more efficiently than a WTRU that does not support the additional packet filter feature. The additional packet filters may be provided in a supplemental QoS rule that is linked to a QoS rule. The supplemental QoS rule may be used to override or supplement the QoS rule. The WTRU may be configured with supplemental QoS rules.

An information element may be generated by the 5GS (e.g., the SMF). The information element may be provided to the WTRU.

The IE may be a NAS information element. The IE may be called a supplemental QoS rule IE. If a WTRU supports interpreting the IE, the WTRU may interpret the IE and use the IE as instructed. If a WTRU does not support interpreting the IE, the WTRU may ignore the IE field.

A WTRU that supports reading, interpreting, and using additional packet filter(s) may be able to interpret the IE. A WTRU that does not support the additional packet filter(s) feature may ignore the supplemental QoS rule IE.

The supplemental QoS rule IE may be provided to the WTRU separately from the QoS rule IE.

The NAS IE may include an indication to the original or legacy QoS rule associated with the additional packet filter IE. The NAS IE may include the linked QoS rule identifier to identify the QoS rule associated with the NAS IE.

The supplemental QOS rule IE may include the additional packet filter information to use. For example, the supplemental QoS rule IE may include the type or format of the additional packet filter. The supplemental QoS rule IE may include a value for the packet filter to which the QFI (e.g., the new QFI) applies. For example, if different service data flows use RTP protocol, the application server may use the stream ID field of the RTP packets to indicate which traffic modality is carried. The stream ID may be included as a type of a packet filter, such as the additional packet filter. In the supplemental QoS rule IE, a stream ID, such as a stream ID of value 2, may be included. A stream ID of value 2 may mean that the service data flow (e.g., corresponding to the original packet filter in the legacy QoS rule) that may have a stream ID of value 2 may (e.g., may need to be) associated with the QoS flow QFI that is part of the supplemental QoS rule IE.

The stream ID may designate a MOQ track or a QUIC stream. The UPF may obtain the MOQ track from a MOQ relay function in the UPF. The WTRU may obtain the MOQ track from the client application (e.g., through a programmatic API). The UPF may obtain the QUIC stream from a MASQUE proxy function in the UPF. The UPF may obtain the QUIC stream from the client application. The UPF/WTRU may obtain the stream ID from a UDP or IP option (e.g., set by the sending application).

The value included in the additional packet filter field may be a single value, a set of values, or a range of values. For example, stream ID equal to 2 or 3 (e.g., with matching legacy packet filter) may receive QFI equal to 10.

The additional packet filter type or format field may include one or more types of packet filter(s).

For example, the additional packet filter may include a stream ID type and a PDU set importance field type. In this case, “Stream ID=2, PSI=2, QFI=10” may mean that the data packets with stream ID equal to 2 and with a PDU set importance value equal to 2 are associated with QFI 10.

The supplemental QoS rule IE element may include a QFI value. This value may be the same as or different from the QFI value in the QoS rule linked to this NAS IE. The QFI (e.g., the new QFI) may override the QFI in the QoS rule linked to the additional packet filter IE.

For example, a packet that matches the packet filter of a QoS rule with QoS rule identifier QRI=1, with QFI originally equal to 10, and using the additional packet filter feature with stream ID=2, may be associated with QFI 20.

The supplemental QoS rule IE may include: the identity of the QoS rule with which it is associated; one or more additional packet filter(s); and/or a QFI value (e.g., for each packet filter) associated with the (e.g., each) additional packet filter(s).

The supplemental QOS rule IE may include a packet filter that is a wild-card value. The supplemental QoS rule IE may include a QFI value to associate with the additional packet filter.

If a non-supporting WTRU receives the supplemental QoS rule IE, the WTRU may ignore the supplemental QoS rule IE.

If a supporting WTRU receives the supplemental QoS rule IE, the supporting WTRU may use the rule in a QoS rule evaluation procedure. An example QoS rule evaluation procedure (e.g., performed by the WTRU) may include one or more of the following.

The WTRU may first detect that traffic (e.g., an uplink PDU) matches the packet filter of a first QoS rule.

The WTRU may then detect that a supplemental QoS rule IE is associated with the first QoS rule. The WTRU may detect that the supplemental QoS rule IE is associated with the first QoS rule based on the supplemental QoS rule IE including the identity of the first QoS rule.

The WTRU may then check if the traffic matches any of the packet filter(s) in the supplemental QoS rule IE, other than a wild-card packet filter in the supplemental QoS rule IE.

If the WTRU determines that the traffic matches one or more packet filter(s) in the supplemental QoS rule IE (e.g., other than any wild-card packet filter), the WTRU may associate the traffic with the QFI value that is associated with the highest priority packet filter.

If the WTRU determines that the traffic does not match one or more packet filter(s) in the supplemental QoS rule IE and the supplemental QoS rule IE includes a wild-card packet filter, the WTRU may associate the traffic with the QFI value that is associated with the wild-card packet filter.

If the WTRU determines that the traffic does not match one or more packet filter(s) in the supplemental QoS rule IE and the supplemental QoS rule IE does not include a wild-card packet filter, the WTRU may associate the traffic with the QFI value that is associated with the QoS rule.

The WTRU may transmit the traffic with the QFI value that was determined to be associated with the traffic.

FIGS. 2A and 2B illustrate configuration and provisioning of additional packet filter IE to the WTRU. FIGS. 2A and 2B illustrate QoS flow handling based on detection of WTRU support of the feature.

At 1, the application function may send a request to the 5GS to reserve resources for an AF session for the XRM traffic. The request may be sent to the network (e.g., via the NEF). The request may be sent (e.g., directly) to the PCF. The AF may include, in the request message, one or more traffic descriptor(s) for the XRM traffic. For example, the AF may include one or more IP 5-tuples (e.g., source IP address, destination IP address, port numbers, and protocol information) for the traffic.

If the traffic is multiplexed (e.g., multiple traffic flows are multiplexed into the same service data flow described by the provided IP 5-tuple), the AF may include additional packet filter information (e.g., to help identify the different multiplexed flows). For example, in the case of packets transported from the AS via RTP packets, the AF may include a stream ID in the additional packet filter information. The AF may include a packet filter type (e.g., a stream ID), and one or more value(s) for the additional packet filter.

For example, the AF may indicate that multiplexed traffic may be (e.g., further) differentiated using a stream ID filter. The AF may indicate that there are packets belonging to stream ID 1, stream ID 4, and stream ID 6 (e.g., multiplexed together).

The AF may provide a protocol ID to indicate how the stream ID may be obtained by the UPF or WTRU. The protocol ID may be provided in the rules to the WTRU and UPF.

The AF may include (e.g., for each multiplexed traffic) a QoS reference or QoS parameter(s) (e.g., to identify the requested QoS treatment needed for each traffic flow of the multiplexed traffic).

For a (e.g., each) traffic flow of the multiplexed traffic, the AF request may include a requested 5GS delay, requested packet error rate, requested GBR, requested MBR, and/or the like.

The AF message may include a QoS reference or QoS parameter(s) for the multiplexed traffic described by the IP 5-tuple. The parameters may include a requested 5GS delay, requested packet error rate, a requested GBR, a requested MBR, and/or the like.

The AF may provide the individual QoS parameters of a (e.g., each) traffic flow of the multiplexed stream, to allow for a WTRU that supports this differentiation to have a more granular QoS treatment for the traffic flows.

The AF may provide QoS parameter(s) for the multiplexed traffic described by the IP 5-tuple, to allow for a WTRU that does not support the differentiation of multiplexed flows to send and receive the traffic flow with proper QoS treatment. The parameters may include a requested delay, packet error rate, GBR for the multiplexed flows, MBR for the multiplexed flows, and/or the like.

The AF may provide filter(s) that are able to be used to identify flows of the multiplexed traffic. The AF may provide QoS requirements (e.g., QoS parameters or a QoS reference) for a (e.g., each) flow of the multiplexed traffic. The AF may provide a first set of default QoS requirements (e.g., QoS parameters or a QoS reference) to be used if the traffic does not match any of the provided filter(s). The AF may provide a second set of default QoS requirements (e.g., QoS parameters or a QoS reference) to be used if the traffic matches one of the provided filter.

The second set of default QoS requirements (e.g., QoS parameters) may be used if the information is used to configure QoS rules in a WTRU that does not support the supplemental QoS rule IE. For example, the second default QoS requirements (e.g., QoS parameters) may be used to build a QoS rule for the WTRU. The first set of default QoS requirements (e.g., QoS parameters) may be used to build the supplemental QoS rule IE. For example, the first set of default QoS requirements may be associated with the wild-card packet filter in the supplemental QoS rule IE.

At 2, the NEF may authorize the application function request. The NEF may forward the request to the PCF (e.g., with the relevant parameters such as traffic flow descriptions and requested QoS parameters). At 2, the information that was received from the AF may be forwarded to the PCF.

At 3, the PCF may receive the AF request (e.g., via the NEF). The PCF may authorize the AF request.

The PCF may identify one or more (e.g., two) sets of QoS parameters to consider.

For example, the first set of QoS parameters may be related to a flow (e.g., each individual flow, for example, an RTP stream) that is multiplexed to the traffic flow having the IP 5-tuple or other packet filter. For example, if there are three flows that are to be multiplexed in a (e.g., single) transport connection (e.g., with additional packet filter with type stream ID, and values stream ID 1, 4, and 6), the first set of QoS parameters may include QoS-1 parameters for stream ID 1, QoS-2 parameters for stream ID 4, and QoS-3 parameters for stream ID 6. The QoS parameters may be similar or different. The first set of QoS parameters may be provisioned for a WTRU that supports the additional packet filter feature.

The service requirement(s) (e.g., service parameters) of the (e.g., individual) service data flows that are multiplexed may include a guaranteed bit rate value (GBR) and/or a maximum bit rate (MBR) (e.g., for each of the data flows).

The second set of QoS parameters may be related to the traffic flow that is described by the original packet filter (e.g., IP 5-tuple, without the additional packet filter information) derived from service specifications/requirements (e.g., parameters) from the AF request. The second set of QoS parameters may include a GBR value and/or a MBR value for the multiplexed traffic flow. The second set of QoS parameters may be provisioned for a WTRU that does not support the additional packet filter feature.

For example, the GBR value for stream ID 1, 4, and 6 may be 5 Mbps, 10 Mbps, and 15 Mbps, respectively (e.g., for each of the data flows). The GBR value for the multiplexed flow may be 30 Mbps.

In an example, the MBR value for stream ID 1, 4, and 6 may be 20 Mbps for the data flows (e.g., each data flow). The MBR value for the multiplexed flow may be 60 Mbps.

For one or more of the differentiated data flows, the data flows may not use (e.g., require) a guaranteed bit rate (e.g., a non-GBR flow).

The PCF may use the received information from the request to generate PCC rules.

The PCF may use information about WTRU or user authorization to use the additional packet filter feature (e.g., to determine which PCC rules to generate). For example, a user that is not authorized to use the additional packet filter feature may not be provided with granular QoS for multiplexed traffic (e.g., regardless of if the WTRU supports the feature). In an example, a WTRU or user that is authorized to use the feature may be provided with granular QoS treatment (e.g., two sets of PCC rules), for example, depending on whether the WTRU supports the additional packet filter. The PCF may retrieve the authorization information from the WTRU subscription, for example, from the UDM.

The PCF may consider the first set of QoS parameters for the traffic flows. If the first set of QoS parameters are not provisioned by the 5GS, the PCF may consider the second set of QoS parameters (e.g., as a fallback set of QoS parameters).

One or more PCC rules may include service flow information for a (e.g., each individual) traffic flow of the multiplexed traffic flow. The service data flow may include the packet filter information (e.g., IP 5-tuple) that helps identify the multiplexed traffic. The service data flow template may be extended to include the additional packet filter information. The additional packet filter information may be included in the PCC rule (e.g., separately from the service data flow template field).

For example, the additional packet filter information may include a type or format with value “stream ID.” The additional packet filter information may include value stream ID 1, stream ID 4, or stream ID 6 (e.g., for each traffic flow).

The PCC rule(s) may include QoS parameter(s) corresponding to the traffic identified by the service data flow information and the additional packet filter information. The PCC rule(s) may include the authorized 5QI or QoS parameters for a (e.g., each) service data flow. This information may be included in the (e.g., same) PCC rule. This information may be included in separate PCC rules (e.g., for each of the individual service data flows of the multiplexed traffic flow).

The PCF may generate a second PCC rule, substitute, or fallback PCC rule for the second set of QoS parameters. The second PCC rule may include the service data flow template that includes the packet filter information for the multiplexed traffic flow. For example, the PCC rule may include the IP 5-tuple in the service data flow template.

The PCC rule may include the 5QI value or QoS parameters for the multiplexed traffic flow.

The second PCC rule may describe the treatment to be applied if the WTRU does not support the supplemental QoS rule IE.

The traffic flow for the multiplexed traffic flow may be (e.g., initially) associated with the default QoS flow. For example, if the resources for the differentiated traffic flows were established or reserved (e.g., different QoS parameters), and the WTRU supports the additional packet filter feature, the second or substitute PCC rule may not be used for the WTRU. In this case, the traffic flow may be (e.g., initially) associated with the default QoS flow.

The PCC rule may include the (e.g., different) QoS parameters authorized for the service data flow of the multiplexed traffic. In the PCC rule, the field “Bind to QoS flow associated with the default QoS rule” in the PCC rule may be set to “yes” or 1 or a value that indicates that the PCC rule is to be bound to the default QoS flow and the QoS parameters in the PCC rule are to be ignored. The field “Bind to QoS Flow associated with the default QoS rule and apply PCC rule parameters” may be set to “yes” or 1 or a value that indicates that the PCC rule is to be bound to the default QoS flow of the PDU session and that the QoS parameters in the PCC rule are to be used for the default QoS flow (e.g., instead of the default parameters).

A field (e.g., another field) may indicate that the PCC rule is to be bound to the default QoS flow.

The PCF may determine a correlation ID or association ID between the first and second set of PCC rules.

The PCF may determine or assign a precedence value for a (e.g., each) PCC rule. The PCF may assign a precedence value for the second set of PCC rule(s) or substitute PCC rule (e.g., a precedence value that is higher than the first set of PCC rule(s)). In this case, the substitute PCC rule may be evaluated after the first set of PCC rule(s) have been evaluated.

At 4, the PCF may send the PCC rules to the SMF.

The SMF may use the received PCC rules to generate N4 rules for the UPF, QoS profile, and/or QoS rule(s) for the WTRU.

The SMF may use the first set of PCC rules to generate N4 rules for the UPF.

The SMF may generate packet detection rules (PDRs). For a (e.g., each individual) traffic flow of the multiplexed service flow, the SMF may generate a PDR. The PDR may include a rule ID to identify the PDR. The PDR may include packet detection information. The packet detection information may include information to identify the traffic flow (e.g., packet filter set, protocol description, and/or the like).

The packet detection information (PDI) may include additional packet filter information. The packet filter information may be a separate field in the packet detection information or part of the packet filter set field.

The PDI may include the QoS flow ID for the traffic.

For example, in the packet filter information, the packet filter set may have the IP 5-tuple for the multiplexed traffic. The additional packet filter information may include the type stream ID (e.g., and value stream ID 1, 4, and 6, for each flow respectively).

The SMF may generate (e.g., from the second set of PCC rule(s)) a PDR for the multiplexed traffic. The PDR may include the packet filter information in the packet detection information field (e.g., without additional packet filter information). The PDR may include the QFI indicated in the PCC rule (e.g., QFI of the default QoS flow).

A PDR may have a precedence value. The SMF may set the precedence value for the PDR of the substitute QoS configuration to be higher than the precedence value of the (e.g., individual) traffic flows PDR(s) (e.g., to allow the individual traffic flows PDR(s) to be evaluated first).

The SMF may use the PCC rules to determine QoS enforcement rules (e.g., QERs) for a (e.g., each) packet detection rule for the traffic flow(s) of interest.

For example, for the PDR corresponding to a (e.g., each individual) traffic flow of the multiplexed service flow, the QER may include QoS flow ID, guaranteed bit rate value, and maximum bit rate value.

The PDR corresponding to the multiplexed traffic flow may include a QER that has QFI value of the default QoS flow ID.

The SMF may use the PCC rules to determine forwarding action rules (i.e., FARs) for the (e.g., each) packet rule for the traffic flow(s) of interest.

The FARs may include a forwarding rule for the traffic identified in the PDR (e.g., uplink or downlink traffic).

The SMF may use the PCC rules to derive QoS profile for the RAN node.

The QoS profile may include information about the QoS flows for the PDU session that carries the traffic of interest (e.g., and QoS parameters for the QoS flows).

The QoS profile may include the QoS flow IDs corresponding to the QoS flow IDs that are associated with a (e.g., each individual) traffic flow of the multiplexed service flow.

For a (e.g., each) QFI, the QoS profile may include the 5QI or QoS parameters. If the QoS flows are GBR, the QoS profile may include a guaranteed flow bit rate (GFBR) value for uplink and downlink traffic, and/or a maximum flow bit rate (MFBR) value for uplink and downlink traffic.

The QoS profile may include the information related to the QoS flow associated with the multiplexed traffic flow. For example, the QoS profile may include the QFI of this QoS flow (and/or 5QI or QoS parameters).

The QoS profile may include an association ID or correlation ID for the QoS flows of the individual traffic flows and the QoS flow of the multiplexed flow. The QoS profile may include (e.g., for the QoS flow that carries the multiplexed flow) an indication that the traffic flow with an association ID of value x is associated with a traffic flow that is multiplexed, a substitute traffic flow, or carries traffic related to fallback PCC rules.

The SMF may use the PCC rules to generate QoS rule(s) and supplemental QoS rule IE type of information to be used by the WTRU.

The SMF may generate a QoS rule for multiplexed traffic. This QoS rule may include packet filter set information. The packet filter set information may represent the packet filter information of the multiplexed traffic (e.g., without the additional packet filter information). The QoS rule may include the QFI of the QoS flow that may carry the traffic of interest. The QoS rule may include a precedence value for the QoS rule, and/or a QoS rule identifier (QRI) for the rule.

The SMF may use the PCC rules to generate a supplemental QoS rule IE for the QoS handling with the additional packet filter feature.

The supplemental QOS rule IE may include the identifier of the QoS rule (QRI) to which the additional packet filter or differentiated traffic flow is associated. In this case, the QRI of the QoS rule that includes the packet filter information of the multiplexed traffic flow may be included in the supplemental QoS rule IE.

The supplemental QoS rule IE may include additional packet filter information. For example, the supplemental QoS rule IE may include the type or format of the additional packet filter information and/or one or more associated values.

For example, the supplemental QoS rule IE may include additional packet filter information of type stream ID and value stream ID 4.

The supplemental QoS rule IE may include a QFI value (e.g., to identify the QFI value to use for the traffic that is further identified using the additional packet filter information included in the supplemental QoS rule IE).

For example, the supplemental QoS rule IE may have a QRI (identifier of the QoS rule) of value 10. The QoS rule with QRI 10 may have a QFI of value 5. The supplemental QoS rule IE may have additional packet filter type stream ID and value stream ID 4. The supplemental QoS rule IE may include a QFI value equal to 2 (e.g., QFI=2).

The QFI value in the supplemental QoS rule IE may be used (e.g., instead of the QFI value in the QoS rule with the identified QRI).

The SMF may generate supplemental QoS rule IE information corresponding to a (e.g., each individual) traffic flow identified with the additional packet filter information. For example, the SMF may generate a supplemental QoS rule IE for traffic flow of stream ID 1, stream ID 4, and stream ID 6, respectively. The QFI value in the supplemental QoS rule IE may correspond to the QFI of the QoS flow that would carry the (e.g., individual) traffic flows.

The additional packet filter information may be generated using the information from the first set of PCC rules.

The QRI may refer to the identifier of the QoS rule that the SMF generated for the multiplexed traffic flow.

The supplemental QoS rule IE may include a precedence value for the order of evaluation of the supplemental QoS rule IE.

The supplemental QoS rule IE may have an IE identifier (e.g., to be able to identify the IE element identity).

The supplemental QoS rule IE may include the association ID. The association ID may be used to associate the supplemental QoS rule IE and the QoS rule IE.

The SMF may use a first set of PCC rules to generate a supplemental QoS rule IE. The SMF may use a second set of PCC rules to generate a QoS rule IE. The supplemental QoS rule IE may include the identity of the QoS rule IE. The PCF may send an indication (e.g., to the SMF) that the first PCC rule and second PCC rule are associated with each other.

At 5a, the SMF may send the N4 rules to the UPF.

At 5b, the SMF may send the QoS profile to the RAN (e.g., via the AMF).

At 5c, the SMF may send the generated QoS rules and the supplemental QoS rule IE to the WTRU. The SMF may use the PDU session modification command request message to send the QoS rules and the supplemental QoS rule IE to the WTRU (e.g., via the AMF).

If the WTRU does not support the supplemental QoS rule IE, the WTRU may ignore the supplemental QoS rule IE that was sent by the SMF. In this case, the WTRU may receive, process, and store the QoS rules.

If the WTRU supports the additional packet filter feature, the WTRU may interpret the supplemental QoS rule IE. The WTRU may process and store the supplemental QoS rule IE (e.g., in addition to the QoS rules).

At 6 (e.g., upon successful processing and storage of the QoS rules and potentially supplemental QoS rule IE), the WTRU may send a PDU session modification command complete message.

The PDU session modification command complete message may include the PDU session ID of the PDU session that carries (e.g., would carry) the traffic flow of interest.

If the WTRU does not support the additional packet filter feature, the WTRU may have ignored the supplemental QoS rule IE information in the PDU session modification command message received from the SMF.

If the WTRU supports the additional packet filter feature, the WTRU may have processed and stored the supplemental QoS rule IE received from the SMF. In this case, the WTRU may include, in the PDU session modification command complete message, an indication that the additional packet filter feature is provisioned for the PDU session. This indication may include the association ID that was generated by the PCF for the corresponding PCC rules. This message may include the identifier of the supplemental QoS rule IE that was (e.g., successfully) authorized or provisioned by the WTRU.

At 7, the SMF may receive the PDU session modification command complete message from the WTRU.

The SMF may examine the PDU session modification command complete message. If the PDU session modification command complete message includes an indication that the additional packet filter (e.g., included in the supplemental QoS rule IE) is supported, that the additional packet filter feature is successfully provisioned for the PDU session, the identifier(s) of the supplemental QoS rule IE that were successfully provisioned by the WTRU, or an association ID, the SMF may determine (e.g., deduce) that the WTRU supports the additional packet filter feature (e.g., and that it is successfully provisioned for the PDU session).

If the message received by the SMF does not include an indication related to the support or provisioning of the additional packet filter feature by the WTRU, the SMF may determine (e.g., consider) that the WTRU does not support the feature. If the WTRU does not include an indication related to the support or provisioning of the additional packet filter feature in the PDU session modification command complete message, the SMF may be configured to (e.g., or instruct the UPF to) perform packet detection to be able to determine whether the WTRU is supporting the feature.

Providing the SMF with an indication of whether the WTRU supports the feature may allow the SMF to be aware of which QoS rules the WTRU is applying. In this case, the SMF may know how many network resources the WTRU's traffic is expected to consume. The SMF may consider this information when reserving resources for other traffic flows (e.g., of the same WTRU or different WTRUs). The support indication may be provided to the SMF after the QoS rules are sent to the WTRU. The SMF may not (e.g., may not need to) consider the WTRU's support for the feature when the WTRU QoS rules are derived by the SMF.

If a WTRU does not provide its indication (e.g., using the PDU session modification complete message) for support of the feature right away, the WTRU may want to indicate its support at a later point in time. In this case, the WTRU may store the information received from the SMF. The WTRU may inform the SMF (e.g., at a later point in time, for example, via a PDU session modification request message) that the WTRU supports the feature.

At 8, the application hosted at the WTRU may (e.g., be ready to) send uplink traffic.

The WTRU may determine packet filter information related to the uplink traffic to send to the application server.

If the WTRU determines a QoS rule that includes packet filter set information that matches the traffic flow description of the uplink traffic, the WTRU may determine the identifier of the QoS rules and/or QRI value.

If the WTRU does not support the additional packet filter feature, the WTRU may use the determined QoS rule to determine the QFI of the QoS flow that may carry the uplink traffic. The WTRU may use the QFI to associate this uplink traffic with the QoS flow.

If the WTRU supports the additional packet filter feature, the WTRU may determine to check if there is supplemental QoS rule IE information (e.g., associated with the QoS rule that was previously determined) stored at the WTRU.

The WTRU may use the precedence rules of the supplemental QoS rule IE elements to check whether the QRI value in the supplemental QoS rule IE in the WTRU corresponds to the QRI of the QoS rule of interest.

If the WTRU does not find a (e.g., any) supplemental QOS rule IE that is associated with the QoS rule, the WTRU may determine that the traffic flow associated with the QoS rule may not have differentiated QoS handling for different traffic flows of a multiplexed service flow. In this case, the WTRU may use the QoS rule and the QFI value included in the QoS rule to determine the QoS flow that would carry the uplink traffic (e.g., if the uplink traffic is not differentiated).

If the WTRU finds at least one supplemental QoS rule IE element that includes a QRI value that matches the identifier of the previously determined QoS rule, the WTRU may determine to process the supplemental QoS rule IE.

The WTRU may (e.g., first) check the additional packet filter information included in the supplemental QoS rule IE of interest.

The WTRU may use the type or format of the additional packet filter to determine to check

additional packet filter information associated with the uplink traffic to be sent. For example, if the additional packet filter type in the supplemental QoS rule IE may be a stream ID, the WTRU may determine the stream ID of the uplink packets to be sent.

The WTRU may use the value corresponding to the additional packet filter type. The WTRU may check whether the value that corresponds to the uplink packets matches the value that is included in this supplemental QoS rule IE.

If the values match, the WTRU may proceed (e.g., perform further actions).

For example, if the stream ID of the uplink packets is stream ID 4, this may correspond to the value in the supplemental QoS rule IE.

If the value corresponding to the uplink packets does not correspond to the value in the supplemental QoS rule IE element, the WTRU may check another (e.g., the following) supplemental QoS rule IE element (e.g., based on precedence value) that includes a QRI that matches the QRI of the QoS rule of interest (e.g., and so on).

If the WTRU does not find a (e.g., any other) supplemental QoS rule IE element with a QRI value matching the QRI value of the QoS rule of interest, the WTRU may use the QFI in the QoS rule to carry the uplink traffic of interest. If the WTRU does not find a (e.g., any other) supplemental QoS rule IE element with a QRI value matching the QRI value of the QoS rule of interest, the WTRU may determine to discard the uplink traffic. For example, because the additional packet filter feature is supported, the supplemental QoS rule IE may have a QRI value that matches the QoS rule of interest. In this case, the supplemental QoS rule IE may not have a matching additional packet filter information value. The WTRU may determine to drop or discard the packets (e.g., similar to the situation in which no QoS rule with a matching packet filter set is found by the WTRU).

If the WTRU finds an erroneous QFI value or no QFI value in the supplemental QoS rule IE element, the WTRU may discard the uplink packets. In this case, the WTRU may (e.g., be triggered to) request that the network check or update the supplemental QoS rule IE lists. The request message may include the PDU session ID, the supplemental QoS rule IE identifier to check, and an error or update/check reason code for the request message. In response, the network may update the supplemental QoS rule IE elements for the WTRU. The network may perform a WTRU configuration update procedure with the WTRU.

If the values of the additional packet filter information element match, the WTRU may check the value of the QFI included in the supplemental QoS rule IE. The WTRU may use the QFI value to determine the QoS flow that is associated with the uplink traffic and that would carry this uplink traffic.

If a non-supporting WTRU receives the supplemental QoS rule IE, the supplemental QoS rule IE may be ignored by the WTRU.

If a supporting-WTRU receives the supplemental QoS rule IE, the supporting WTRU may use the rule in a QoS rule evaluation procedure. An example QoS rule evaluation procedure that the WTRU performs may be as follows.

The WTRU may (e.g., first) detect that traffic (e.g., an uplink PDU) matches the packet filter of a first QoS rule.

The WTRU may detect that a supplemental QoS rule IE is associated with the first QoS rule. The WTRU may detect that the supplemental QoS rule IE is associated with the first QoS rule based on the supplemental QoS rule IE (e.g., including the identity of the first QoS rule).

The WTRU may check if the traffic matches any of the packet filter(s) in the supplemental QoS rule IE (e.g., other than any wild-card packet filter in the supplemental QoS rule IE).

If the WTRU determines that the traffic matches one or more packet filter(s) in the supplemental QoS rule IE (e.g., other than any wild-card packet filter), the WTRU may associate the traffic with the QFI value that is associated with the highest priority packet filter.

If the WTRU determines that the traffic does not match one or more packet filter(s) in the supplemental QoS rule IE and the supplemental QoS rule IE includes a wild-card packet filter, the WTRU may associate the traffic with the QFI value that is associated with the wild-card packet filter.

If the WTRU determines that the traffic does not match one or more packet filter(s) in the supplemental QoS rule IE and the supplemental QoS rule IE does not include a wild-card packet filter, the WTRU may associate the traffic with the QFI value that is associated with the QoS rule.

The WTRU may transmit the traffic with the QFI value that was determined to be associated with the traffic.

At 9 (e.g., if the operation is successful), the WTRU may send the uplink traffic to the application server (e.g., using the determined QoS flow ID to the UPF, for example, via the RAN node). The packet (e.g., PDU) and QFI may be sent to the network.

At 10 (e.g., once the RAN receives the uplink packets), the RAN node may determine the QFI value received in the header of the uplink packets. The RAN node may send the uplink packets in a GTP-U packet that includes the determined QFI value in the GTP-U header. The RAN may send the uplink traffic to the UPF.

At 11, the UPF may receive the uplink traffic from the RAN node. The UPF may determine packet filter information corresponding to the received uplink packets. For example, the UPF may determine the IP 5-tuple of the uplink packets.

The UPF may determine the packet detection rule(s) that include packet detection information that matches the determined packet filter information (e.g. 5-tuple) of the uplink traffic. For example, the UPF may determine, using the PDR or packet filter set of the PDI included in the PDR, that uplink traffic is matched, if the IP 5-tuple of the uplink of the packets matches the IP 5-tuple of the PDI.

The UPF may use the QFI value carried using the uplink packet to determine the correct packet detection rule. The UPF may use the packet filter set and QoS flow ID to determine that the uplink packet matches the PDR rule.

If the packet detection information part of the considered PDR includes further additional packet filter information, or the PDR includes a field related to additional packet filter information, the UPF may check the additional packet filter information to determine whether the PDR matches the uplink packet traffic description information.

If the WTRU does not support the additional packet filter feature and uses a QoS rule to send the uplink traffic to the substitute or fallback QoS flow, the WTRU may send the uplink packet. The WTRU may include the QFI in the QoS rule in the packet's header information. The RAN may encapsulate the uplink packet in a GTP-U packet. The RAN may include the QFI value in the GTP-U header of the GTP-U packet. In this case, the UPF may use the packet filter information (e.g., in the packet detection information of the PDRs) and the QFI value to find the PDR that corresponds to the uplink traffic. In this case, if the PDR includes (e.g., further) additional packet filter information, the PDR that corresponds to the uplink traffic may not have the additional packet filter information in the PDI or in another field in the PDR (e.g., because the uplink packet does not include this information).

If the UPF matches the traffic flow description of the uplink packet to a PDR that includes the additional packet filter information, the UPF may determine (e.g., if not already determined) that the WTRU supports the additional packet filter feature (e.g., the WTRU is using the feature to carry uplink traffic).

If the UPF matches the traffic flow description of the uplink packet to a PDR that does not include the additional packet filter information, the UPF may determine that the WTRU does not support the additional packet filter feature (e.g., because the WTRU is using the substitute or fallback QoS flow to carry the uplink traffic of interest).

At 12, the UPF may send the uplink traffic to the AS.

At 13, the UPF may send the determination of whether the WTRU supports additional packet filter features to the SMF. The UPF may send an indication to the SMF that the UPF detected uplink traffic related to specific packet detection rules (PDRs).

The UPF may (e.g., have been configured by the SMF to) notify the SMF if the UPF detects that the WTRU sends traffic that matches a (e.g., certain) PDR and QoS flow ID. The notification from the UPF to the SMF may be used by the SMF to detect whether the WTRU supports the supplemental QoS rule IE. For example, the supplemental QoS rule IE may indicate that traffic of a first type is associated with a first QoS flow ID. The associated QoS rule may map traffic from the associated IP flow to a second QoS flow ID. If the UPF indicates to the SMF that the traffic is being mapped to the first QoS flow ID, the SMF may determine that the WTRU supports the supplemental QoS rule IE feature. If the UPF indicates to the SMF that the traffic is being mapped to the second QoS flow ID, the SMF may determine that the WTRU does not support the supplemental QoS rule IE feature.

The UPF may provide the SMF with information to determine whether the WTRU supports the supplemental QoS rule IE feature. The WTRU may send a support indication in the PDU session modification command complete message (e.g., at 7).

As described herein, providing the SMF with an indication of whether the WTRU supports the feature may allow the SMF to be aware of which QoS rules the WTRU is applying. The SMF may know how many network resources the WTRU's traffic is expected to consume.

At 14, the SMF may receive information regarding the PDR or the additional packet filter feature from the UPF.

The SMF may determine (e.g., based on the traffic detection indication from the UPF) whether the additional packet filter feature is supported. The SMF may determine (e.g., based on the traffic detection indication from the UPF) whether the additional packet filter feature is well provisioned at the WTRU.

If the SMF determines that the WTRU supports the additional packet filter feature for the PDU session and for the traffic flow of interest, the SMF may determine that the substitute/fallback QoS flow or the substitute/fallback N4 rules are not to be used (e.g., are no longer needed). The SMF may determine to remove the substitute N4 rules.

At 15, the SMF may send the determination about the WTRU support of the additional packet filter feature for the PDU session (e.g., to the PCF).

If the SMF determines that the WTRU does not support the additional packet filter feature, the SMF may send such an indication to the PCF.

The SMF may consider the WTRU's support for the feature when making resource reservation decisions for the traffic flows (e.g., traffic flows of other WTRUs or the same WTRU). Making resource reservation decisions may refer to the WTRU determining QoS rules, supplemental QoS rules, QoS Profiles, and N4 Rules.

At 16, the PCF may determine (e.g., based on the indication from the SMF that the WTRU supports the feature) that the substitute or fallback PCC rules are not to be used (e.g., are no longer needed). In this case, the PCF may determine to remove the second set of PCC rules for the multiplexed traffic flow.

The PCF may consider the WTRU's support for the feature when making resource reservation decisions for the traffic flows (e.g., traffic flows of other WTRUs or the same WTRU). Making resource reservation decisions may refer to the PCF determining PCC rules.

If the notification message received from the SMF indicates that the WTRU does not support the additional packet filter feature (e.g., for the PDU session or the traffic flows), the PCF may determine based on this indication that the first set of PCC rules is not to be used (e.g., is no longer needed). The PCF may determine to remove the first set of PCC rules (e.g., the PCC rules that reflect the QoS parameters and traffic description for the individual traffic flows of the multiplexed service flow).

In this case, the PCF may also determine to update a second set of PCC rules (e.g., related to the multiplexed traffic flow). For example, if the PCC rule (e.g., initially) included a non-guaranteed bit rate as a characteristic of the QoS flow for the multiplexed traffic flow, or if the PCC rule indicates that the multiplexed traffic flow is to be (e.g., needs to be) bound to a default QoS flow, the PCF may update the PCC rules to update the QoS parameters related to the traffic flow of interest. If the PCC rule (e.g., initially) included a non-guaranteed bit rate as a characteristic of the QoS flow for the multiplexed traffic flow, or if the PCC rule indicates that the multiplexed traffic flow is to be (e.g., needs to be) bound to a default QoS flow, the PCF may set the field “Bind to QoS Flow associated with the default QoS rule” of the PCC rule to “no,” zero, or a similar value.

For example, if the multiplexed traffic flow is GBR traffic with a certain GBR value y, the PCC rule of the multiplexed traffic flow may be updated to indicate a guaranteed bit rate with value y for the carrying QoS flow.

If the first set of PCC rules indicates “Bind to QoS Flow associated with the default QoS rule and apply PCC rule parameters,” (e.g., where the QoS parameters of the default QoS flow were changed with those included in the PCC rule of the multiplexed traffic flow) the PCF may update the PCC rule including the original QoS parameters for the traffic flow (e.g., including GBR indication and value y). The PCF may set the field “Bind to QoS Flow associated with the default QoS rule and apply PCC rule parameters” of the PCC rule to “no,” 0, or a similar/corresponding value. The PCF may determine to set the QoS parameters of the default QoS flow to the default QoS parameters (e.g., instead of those of the multiplexed traffic flow). The QoS flow may be non-GBR (e.g., as opposed to the original characteristic of the traffic flow, for example, GBR with value y).

At 17, if the PCF updates or removes the PCC rules, the PCF may send the updated PCC rules or instructions to remove some PCC rules (e.g., to the SMF).

At 18, the SMF may use the updated PCC rules to update the N4 rules, QoS profile, and QoS rules.

The SMF may send this information using a PDU session modification procedure.

The supplemental QoS rule IE elements may not be impacted by the update. The update (e.g., the only update) in the QoS rule may be the QFI value of the QoS flow for the multiplexed value (e.g., if the QoS flow ID has been updated). For example, the multiplexed flow may (e.g., now) be carried using a GBR QoS flow instead of the default QoS flow.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that-in the case where there is more than one single medium-there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

What is claimed:

1. A wireless transmit/receive unit (WTRU), the WTRU comprising:
a processor, wherein the processor is configured to:
receive a first message from a first network node, wherein the first message is a Protocol Data unit (PDU) session modification message that comprises a first Quality of Service (QOS) rule Information Element (IE) and a second QoS rule IE, wherein the first QoS rule IE is associated with a first QoS rule and indicates a first QoS flow ID and a first packet filter, and wherein the second QoS rule IE is associated with a second QoS rule and indicates a second QoS flow ID and a second packet filter;
determine a data packet to be sent to a second network node, wherein the data packet is associated with an application;
determine an uplink (UL) QoS flow identification (ID) associated with the data packet based on at least one of the first QoS rule or the second QoS rule wherein:
on condition that the data packet matches the first packet filter and does not match the second packet filter, the UL QoS flow ID is determined to be the first QoS flow ID, and
on condition that data packet matches the first and second packet filters, the UL QoS flow ID is determined to be the second QoS flow ID; and
send a second message to a second network node, wherein the second message comprises the data packet and indicates the uplink QoS flow ID.

2. The WTRU of claim 1, wherein the second QoS rule IE is a supplemental QoS Rule IE.

3. The WTRU of claim 1, wherein the first packet filter is associated with a first stream ID value, and wherein the second packet filter is associated with a second stream ID value, and wherein the first stream ID value is different from the second stream ID value.

4. The WTRU of claim 1, wherein the processor being configured to determine an uplink QoS flow ID associated with the data packet based on the at least one of the first QoS rule or the second QoS rule comprises the processor being configured to determine that the uplink QoS flow ID is the first QoS flow ID based on the packet matching the first packet filter.

5. The WTRU of claim 1, wherein the processor being configured to determine an uplink QoS flow ID associated with the data packet based on the at least one of the first QoS rule or the second QoS rule comprises the processor being configured to determine that the uplink QoS flow ID is the second QoS flow ID based on the packet matching the second packet filter.

6. The WTRU of claim 1, wherein the processor being configured to determine an uplink QoS flow ID associated with the data packet based on at least one of the first QoS rule or the second QoS rule comprises the processor being configured to determine that the uplink QoS flow ID is the first QoS flow ID by based on the second QoS rule.

7. The WTRU of claim 1, wherein the processor being configured to determine an uplink QoS flow ID associated with the data packet based on the at least one of the first QoS rule or the second QoS rule comprises the processor being configured to:
determine that the packet matches the first packet filter and the second packet filter;
determine a precedence rule to select the uplink QoS flow ID using the first QoS rule and the second QoS rule; and
select the uplink QoS flow ID using the determined precedence rule.

8. The WTRU of claim 1, wherein the processor is further configured to:
determine that the WTRU supports the second QoS rule; and
send a PDU session modification complete message to the first network node, wherein the PDU session modification complete message indicates that the WTRU supports the second QoS rule.

9. A first network node, wherein the first network node comprises:
a processor, wherein the processor is configured to:
receive a first message from a second network node, wherein the first message indicates a first policy and charging control (PCC) rule, a second PCC rule, and an indication that the first PCC rule is associated with the second PCC rule;
determine that the second PCC rule is to be applied to a wireless transmit/receive unit (WTRU) that supports a supplemental Quality of Service (QOS) rule feature;
determine a first QoS rule using the first PCC rule;
determine a second QoS rule using the second PCC rule, wherein the second QoS rule is a supplemental QoS rule;
send a second message to the WTRU, wherein the second message comprises a first Quality of Service (QOS) rule Information Element (IE) and a second QoS rule IE, wherein the first QoS rule IE is associated with a first QoS rule and indicates a first QoS flow ID and a first packet filter, and wherein the second QoS rule IE is associated with a second QoS rule and indicates a second QoS flow ID and a second packet filter; and
send a third message to a third network node, wherein the third message indicates that the WTRU supports the supplemental QoS rule feature.

10. The first network node of claim 9, wherein the second QoS rule IE further indicates that the second QoS rule is associated with the first QoS rule.

11. The first network node of claim 9, wherein the first packet filter is associated with a first stream identification (ID) value, and wherein the second packet filter is associated with a second stream ID value, and wherein the first stream ID value is different from the second stream ID value.

12. The first network node of claim 9, wherein the processor is further configured to receive a PDU session modification complete message from the WTRU, wherein the PDU session modification complete message indicates that the WTRU supports the second QoS rule.

13. The first network node of claim 9, wherein the processor is further configured to receive a fifth message from the third network node, wherein the fifth message indicates that the WTRU supports the second QoS rule.

14. The first network node of claim 9, wherein the processor is further configured to:
receive a fifth message from the third network node, wherein the fifth message indicates data traffic information; and
determine that the WTRU supports the second QoS rule based on a determination that the data traffic information is associated with the second QoS flow.

15. A method, performed by a wireless transmit/receive unit (WTRU), the method comprising:
receiving a first message from a first network node, wherein the first message is a Protocol Data unit (PDU) session modification message that comprises a first Quality of Service (QOS) rule Information Element (IE) and a second QoS rule IE, wherein the first QoS rule IE is associated with a first QoS rule and indicates a first QoS flow ID and a first packet filter, and wherein the second QoS rule IE is associated with a second QoS rule and indicates a second QoS flow ID and a second packet filter;
determining a data packet to be sent to a second network node, wherein the data packet is associated with an application;
determining an uplink (UL) QoS flow identification (ID) associated with the data packet based on at least one of the first QoS rule or the second QoS rule wherein:
on condition that the data packet matches the first packet filter and does not match the second packet filter, the UL QoS flow ID is determined to be the first QoS flow ID, and
on condition that data packet matches the first and second packet filters, the UL QoS flow ID is determined to be the second QoS flow ID; and
sending a second message to a second network node, wherein the second message comprises the data packet and indicates the uplink QoS flow ID.

16. The method of claim 15, wherein the second QoS rule IE is a supplemental QoS Rule IE.

17. The method of claim 15, wherein the first packet filter is associated with a first stream ID value, and wherein the second packet filter is associated with a second stream ID value, and wherein the first stream ID value is different from the second stream ID value.

18. The method of claim 15, wherein determining an uplink QoS flow ID associated with the data packet based on the at least one of the first QoS rule or the second QoS rule comprises determining that the uplink QoS flow ID is the first QoS flow ID based on the packet matching the first packet filter.

19. The method of claim 15, wherein determining an uplink QoS flow ID associated with the data packet based on the at least one of the first QoS rule or the second QoS rule comprises determining that the uplink QoS flow ID is the second QoS flow ID based on the packet matching the second packet filter.

20. The method of claim 15, wherein determining an uplink QoS flow ID associated with the data packet based on at least one of the first QoS rule or the second QoS rule comprises determining that the uplink QoS flow ID is the first QoS flow ID by based on the second QoS rule.
